(19) United States
(12) Patent Application Publication
(10) Pub. No.: US 2017/0167697 A1
(43) Pub. Date: Jun. 15, 2017

(54) HOUSING FOR USE WITH COLOR CONVERTING MATERIAL ASSEMBLY AND LED

(71) Applicant: SAMSUNG ELECTRONICS CO., LTD., SUWON-SI (KR)

(72) Inventors: MATTHEW STEVENSON, LONG BEACH, CA (US); JAMES ANTHONY CASCARANO, CAMBRIDGE, MA (US); PETER T. KAZLAS, SUDBURY, MA (US)

(21) Appl. No.: 15/377,087

(22) Filed: Dec. 13, 2016

Related U.S. Application Data
(60) Provisional application No. 62/267,001, filed on Dec. 14, 2015.

(51) Int. Cl. F21V 17/16; G02F 1/1335; F21K 9/64; F21V 9/16

(52) U.S. Cl. CPC F21V 17/164; F21V 9/16; G02F 1/133603; G02F 1/133606; G02F 1/133608; G02F 1/133611; F21K 9/64; G02F 2001/133614; F21Y 2115/10

(57) ABSTRACT

A mount for a color converting assembly includes a housing having a first pair of opposed walls and a second pair of opposed walls. The housing has a first opening at a first end thereof and a second opening at a second end thereof. A shelf extends inwardly from each of the walls at a point below the second end of the housing such that each wall extends upwardly beyond the shelf to the second end of the housing. The walls and shelf are formed of a reflective material.

### CLAIM OF PRIORITY

This application claims priority to U.S. Provisional Patent Application No. 62/267,001 filed 14 Dec. 2015, which is hereby incorporated herein by reference in its entirety.

### TECHNICAL FIELD

Aspects of this invention relate generally to a housing for use with a color converting material assembly and, in particular, a housing used to hold a color converting material assembly that includes a chamber containing a color converting material.

### BACKGROUND

Backlights are used for illumination in liquid crystal displays (LCDs) and may use light emitting diodes (LEDs) as the light source. The light from an LED may be projected through a lens and a diffuser, and then on to the LCD. Standard backlights utilize a white LED in the light generating portion of the backlight. The white LED is typically an assembly including a light emitting semiconductor die emitting at higher frequency (e.g., ultraviolet or blue) together with a phosphor or combination of phosphors that converts some portion of the higher frequency light to lower frequency visible light (e.g., green and red). The combination of higher frequency and lower frequency light generates white light. The phosphors used for color conversion in white LEDs are typically a phosphor or combination of phosphors with a broad spectral bandwidth.

### SUMMARY

In certain embodiments described herein, the light generating portion of the backlight utilizes one or more discrete LEDs emitting at higher frequencies (e.g., ultraviolet or blue) that excite a remotely located color converting material containing color converting elements, such as quantum dots (semiconductor nanocrystals), which convert some portion of the higher frequency light to lower frequency visible light (e.g., green and red). The combination of the higher frequency light passing through and/or around the outside of the color converting material and the shorter frequency light emitted by the color converting material gives white light. The narrow spectral bandwidth of the emission peaks of the quantum dots enables higher efficiency and/or wider color gamut backlights as compared with the standard white LED solution. One way to introduce quantum dots (QDs) or other color converting elements into a backlight unit (BLU) is to place them in a glass chamber, between the higher frequency LED illumination and the lens. However, light that passes from the LED through the color converting material to the lens may be multiply scattered and reflected, leading to a loss of efficiency and distortion of the backlight color uniformity. An appropriate mount for the chamber holding the color converting material that is positioned between the LED and the diffuser can be designed to improve efficiency and color uniformity or provide a desired balance between efficiency and color uniformity. The principles of the invention may be used to provide a housing for a chamber containing a color converting material that can be used in a backlight with LEDs.

In accordance with a first aspect, a mount for a color converting assembly includes a housing having a first pair of opposed walls and a second pair of opposed walls. The housing has a first opening at a first end thereof and a second opening at a second end thereof. A shelf extends inwardly from each of the walls at a point below the second end of the housing such that each wall extends upwardly beyond the shelf to the second end of the housing. The walls and shelf are formed of a reflective material.

In accordance with another aspect, an assembly includes a housing having a first pair of opposed walls and a second pair of opposed walls, with the housing having a first opening at a first end thereof and a second opening at a second end thereof. A shelf extends inwardly from each of the walls at a point below the second end of the housing such that each wall extends upwardly beyond the shelf to the second end of the housing. A color converting assembly is seated on the shelf and includes a chamber having a cavity formed therein. A color converting material is received in the chamber.

In accordance with a further aspect, an assembly includes a PCB, an LED secured to the PCB, and a housing having a first end secured to the PCB. The housing includes a first pair of opposed walls and a second pair of opposed walls, with the housing having a first opening at the first end and a second opening at a second end thereof. The LED extends upwardly into the first opening. A shelf extends inwardly from each of the walls at a point below the second end of the housing such that each wall extends upwardly beyond the shelf to the second end of the housing. A color converting assembly is seated on the shelf and includes a chamber having a cavity formed therein. A color converting material is received in the chamber. The assembly can further include a lens positioned at the second end of the housing. Alternatively, a lens can be positioned above the housing. An assembly can further include an LCD positioned above the diffuser. Preferably a first diffuser can be positioned between the lens and the LCD.

The use of a housing for a color converting material assembly can provide higher efficiency and/or wider color gamut backlights than are possible with standard white LED solutions. The housing for the color converting material chamber as described herein can improve efficiency and color uniformity or provide a desired balance between efficiency and color uniformity. These and additional features and advantages disclosed here will be further understood from the following detailed disclosure of certain embodiments.

In accordance with a still further aspect, an assembly includes a PCB, an LED secured to the PCB; and a housing having a first end secured to the PCB. The housing includes a first pair of opposed walls and a second pair of opposed walls, the housing having a first opening at the first end and a second opening at a second end thereof. The LED extends upwardly into the first opening. A shelf extends inwardly from each of the walls at a point below the second end of the housing such that each wall extends upwardly beyond the shelf to the second end of the housing.

It should be appreciated by those persons having ordinary skill in the art(s) to which the present invention relates that any of the features described herein in respect of any particular aspect and/or embodiment of the present invention can be combined with one or more of any of the other features of any other aspects and/or embodiments of the present invention described herein, with modifications as appropriate to ensure compatibility of the combinations. Such combinations are considered to be part of the present invention contemplated by this disclosure.

It is to be understood that both the foregoing general description and the following detailed description are exemplary and explanatory only and are not restrictive of the invention as claimed.

### BRIEF DESCRIPTION OF THE DRAWINGS

FIG. 1 is a schematic elevation view of a housing and color converting assembly in a backlight unit, shown partially exploded.

FIG. 2 is a perspective view of the housing and color converting assembly of FIG. 1.

FIG. 3 is a perspective view, shown partially cut away, of the housing and color converting assembly of FIG. 1.

FIG. 4 is a perspective section view of the housing and color converting assembly of FIG. 1.

FIG. 5 is a perspective elevation view of the housing and color converting assembly of FIG. 1.

FIG. 6 is a perspective section view of an alternative embodiment of the housing and color converting assembly of FIG. 1.

FIG. 7 is a perspective view of an alternative embodiment of the housing and color converting assembly of FIG. 1.

FIG. 8 is a section view of a portion of the housing and color converting assembly of FIG. 7.

FIG. 9 is a perspective top view of the housing of FIG. 7.

FIG. 10 is a perspective bottom view of the housing of FIG. 7.

FIG. 11 is a section view of the housing of FIG. 1, shown attached to a printed circuit board with a fastener.

FIG. 12 is a section view of the housing of FIG. 1, shown attached to a printed circuit board with an alternative embodiment of a fastener.

FIG. 13 is a section view of the housing of FIG. 1, shown attached to a printed circuit board with another alternative embodiment of a fastener.

FIG. 14 is a section view of the housing of FIG. 1, shown attached to a printed circuit board with a further alternative embodiment of a fastener.

FIG. 15 is an elevation view of an alternative embodiment of the housing of FIG. 1, shown with a color converting assembly prior to assembly.

FIG. 16 is an elevation view of the housing of FIG. 15, shown with the color converting positioned within the housing.

The figures referred to above are not drawn necessarily to scale, should be understood to provide a representation of particular embodiments of the invention, and are merely conceptual in nature and illustrative of the principles involved. Some features of the housing and color converting assembly depicted in the drawings have been enlarged or distorted relative to others to facilitate explanation and understanding. The same reference numbers are used in the drawings for similar or identical components and features shown in various alternative embodiments. Housings for use with a color converting material assembly as disclosed herein would have configurations and components determined, in part, by the intended application and environment in which they are used.

### DETAILED DESCRIPTION OF CERTAIN EMBODIMENTS

The following discussion and accompanying figures disclose a housing for use with a color converting material assembly in conjunction with an LED in a backlight. Such a housing and color converting material assembly may be used in a direct lit TV, for example.

An individual skilled in the relevant art will appreciate, given the benefit of this specification, that the concepts disclosed herein with regard to the mount may apply to a wide variety of light applications, in addition to the specific embodiments discussed in the following material and depicted in the accompanying figures.

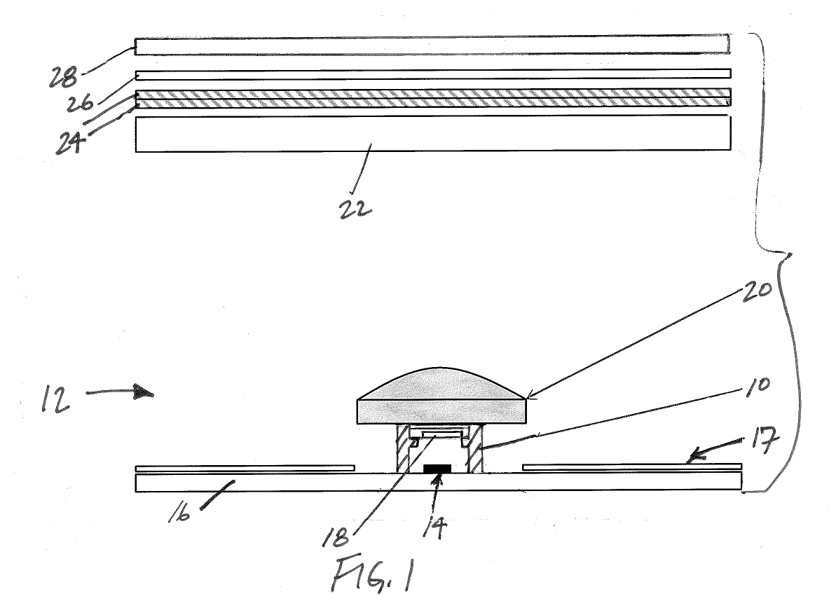

A housing 10 for use in a backlight 12 is depicted in FIG. 1, in partially exploded form. An LED 14 is mounted on a printed circuit board (“PCB”) 16. LED 14 may be soldered or otherwise secured to PCB 16. It is to be appreciated that backlight 12 typically includes a two-dimensional array of LEDs 14 and will have a corresponding number of housings 10. For the sake of simplicity, a single LED 14 and corresponding housing 10 are illustrated here. It is to be appreciated that any number of housings 10 and associated LEDs 14 may be used in backlight 12. A reflective layer 17 may be positioned on PCB outward of housing 10 and LED, and serves to redirect any stray light. Reflective layer 17 may be white to enhance its reflectivity.

It is to be appreciated that housing 10 can be used with a variety of LEDs including, but not limited to, surface mount, dome type, flat top side emitting diodes, and top face emitters. LEDs included in a backlight unit can be selected to emit light with a predetermined peak emission wavelength. For example, LEDs included in a backlight unit can be selected to emit light with a wavelength in the visible or ultraviolet regions of the electromagnetic spectrum. LEDs that emit polychromatic light can also be included. If more than one LED is included, each LED can be selected to emit light with a peak emission that is the same as that of the other LEDs. Alternatively, if more than one LED is included, the LEDs can be selected so that one or more of the LEDs emit light with a peak emission at a wavelength that is different from that emitted by at least one of the other LEDS. In certain embodiments, for example, all of the LEDs can be selected to emit light with a peak emission in the blue region of the visible spectrum or in the ultraviolet region of the spectrum.

Housing 10 receives a color converting assembly 18, and a lens 20 is positioned downstream of housing 10. In certain embodiments, lens 20 is directly in contact with housing 10, while in other embodiments, lens 20 may be spaced from housing 10.

It is to be appreciated that in certain embodiments, lens 20 can be replaced with another transmissive optical device. For example, diffractive elements that use interference and diffraction may be used in place of lens 20. In other embodiments, mirrors could be used in place of lens 20. Other suitable replacements for lens 20 will become readily apparent to those skilled in the art, given the benefit of this disclosure.

Light is transmitted from LED 14 through color converting assembly 18 and lens 20 and then to a first diffuser 22. First diffuser 22 serves to help more evenly distribute the light transmitted from LED 14.

One or more layers of a brightness enhancing film (“BEF”) 24 may be positioned downstream of first diffuser 22, and serve to increase the brightness of the backlight. In the illustrated embodiment, first and second BEFs 24 are shown. BEF 24 may be formed of a sheet of polymer material imprinted with a prismatic surface pattern. BEF 24 serves to help direct the light from the LED, thereby increasing the brightness of the light received by the user. A second diffuser 26 may be positioned downstream of BEF layers 24, with an LCD 28 positioned downstream of second diffuser 26.

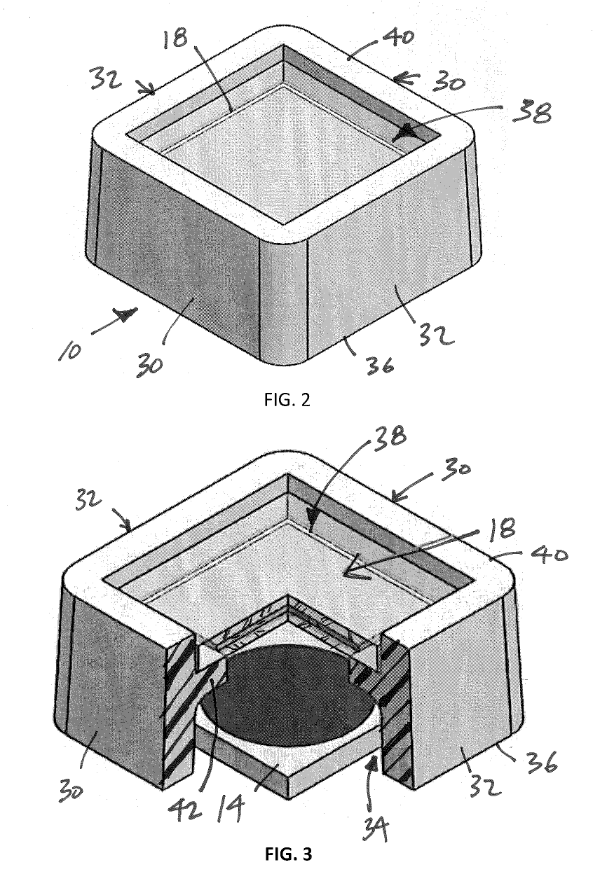

As illustrated in FIGS. 2-5, housing 10 includes a first pair of opposed walls 30 and a second pair of opposed walls 32 connected to the first pair of walls 30. Housing 10 has a first opening 34 at a lower or first end 36 thereof, and a second opening 38 at an upper or second end 40 thereof.

A shelf 42 extends inwardly from each of first walls 30 and second walls 32 about a periphery of an interior of housing 10. Shelf 42 is positioned beneath second end 40 of housing 10 such that a portion of each of first walls 30 and a portion of each of second walls 32 extends upwardly beyond shelf 42 to second end 40. Shelf 42 serves to provide support for color converting assembly 18.

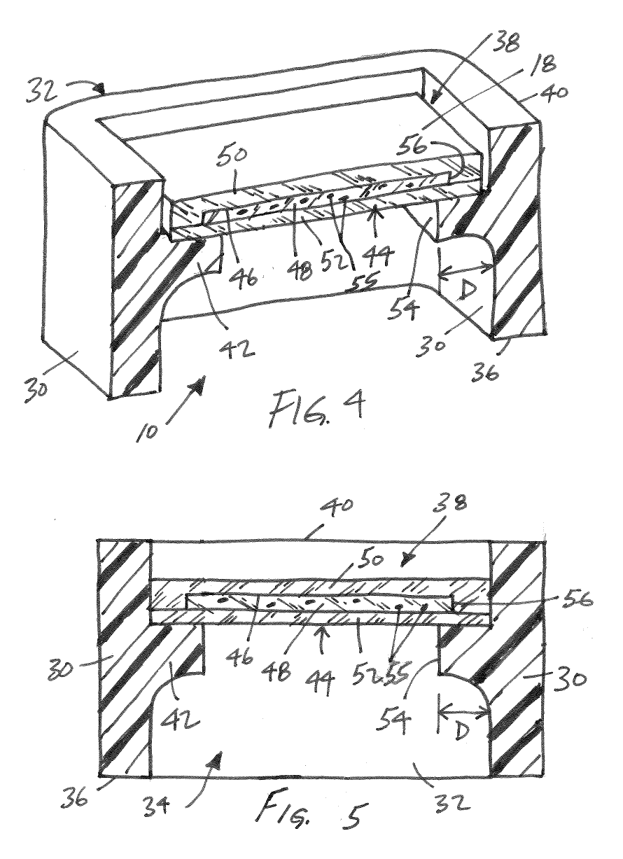

Color converting assembly 18 may include a chamber 44 having a cavity 46 formed therein. A color converting material 48 is received in cavity 46. In certain embodiments, chamber 44 may be formed of an upper or first portion 50 and a lower or second portion 52. In the illustrated embodiment, cavity 46 is formed in a bottom surface of first portion 50, and second portion 52 is secured to first portion 50, covering cavity 46 and color converting material 48 contained therein. In certain embodiments, as illustrated in FIG. 6, first portion 50 of chamber 44 may be positioned beneath second portion 52, with cavity 46 being formed in a top surface of first portion 50.

Chamber 44 may be formed of glass or any other optically clear solid material member. An optically clear solid material has low optical absorption over the spectral range of interest (i.e. the visible) to maximize efficiency. In certain embodiments, the optical absorption may be less than 0.1% per mm.

The color converting material 48 could include one or more color converting elements such as, for example, quantum dots, phosphors, or fluorescent material. It is to be appreciated that color converting material 48 may contain a single color converting element or any combination of multiple color converting elements. Other suitable color converting elements suitable for use in color converting material 48 will become readily apparent to those skilled in the art, given the benefit of this disclosure.

Preferred color converting materials include quantum dots that emit light with a full width less than or equal to 35 nm. A color converting material preferably further comprises an optically transparent or clear matrix in which the color converting component is dispersed or distributed. A color converting material can further include one or more additional additives. Examples of such additives include, without limitation, scatterers or scattering particles, a thixotrope, and an emission stabilizer. Descriptions of exemplary optical materials suitable for use as or inclusion in a color converting materials and exemplary components suitable for inclusion therein are disclosed in U.S. patent application Ser. No. 14/284,277 filed 21 May 2014 of Nick, et al. and WO 2014/018090 of QD Vision, Inc., published 30 Jan. 2014, each of which is hereby incorporated herein by reference in its entirety.

In certain embodiments, it is desirable for color converting assembly 18 to have very low permeability to oxygen to extend the lifetime of quantum dots contained within color converting material 48. In certain embodiments, the permeability is less than approximately 0.01 cc per square meter per day. Most preferably, the color converting assembly is hermetically sealed.

The higher frequency light emitted from the LED may have a narrower angular distribution than the lower frequency light emitted from the color converting material. The difference in angular distribution between lower frequency and higher frequency light may increase BLU color nonuniformity. To better match the angular profiles between higher and lower frequency light, and achieve a more uniform angular emission pattern light, light scattering particles, or scatterers 55, may be added to color converting material 48 to achieve a more uniform angular emission pattern. The scatterers are sub-wavelength size particles with refractive index significantly higher than that of the matrix and are often composed of titanium dioxide, zinc oxide, antimony oxide, or mixtures thereof.

With scatterers 55, the light that would otherwise pass through color converting material 48 is diffusely reflected. Some portion of the diffusely reflected light enters color converting material 48 where it is scattered and/or converted by the color converting elements. Scatterers 55 inside color converting material 48 provide better color uniformity and also enable the use of lower color converting element concentrations. It is to be appreciated that there is a tradeoff between improved color uniformity and lower efficiency due to the scattering process. Scatterers 55 may be formed of sub-wavelength size particles with significantly higher index of refraction than that of the matrix material, such as titanium dioxide, zinc oxide, antimony oxide, or suitable combinations. Other suitable materials for scatterers 55 will become readily apparent to those skilled in the art, given the benefit of this disclosure.

Light interacting with scatterers 55 will be scattered within a specific range of directions according to the size and index of refraction of the particles. If the scattering profile is sufficiently widely distributed in angle, the higher frequency light will derive a wider angular profile that may better match the angular emission profile of the color converting element. However, in this case, more higher frequency light will scatter away from the forward direction and interact with peripheral absorbing structures such as the LEDs and holder, and the efficiency will be lower. Thus, an appropriate scatterer may be used as a lever to balance efficiency and color uniformity.

Descriptions of exemplary color converting assemblies are disclosed in WO2014/085424, entitled “LED Lighting Devices With Quantum Dot Glass Containment Plates,” and WO2015/0159894, entitled “LED Lighting Devices,” the disclosures of each of which are incorporated by reference herein in their entirety.

Housing 10 operates to maintain color converting material 48 at a desired location with respect to LED 14. Housing 10 can also operate to maintain color converting material 48 at a desired location with respect to lens 20 (if included), and to redirect light that would otherwise not be injected into lens 20 into a more efficient direction. Housing 10 may also serve to direct more higher frequency light from LED 14 into color converting material 48 to improve backlight efficiency.

Housing 10 may also dissipate heat produced by LED 14 and color converting material 48.

Housing 10 may be electrically insulating, high in diffuse or specular bulk reflectivity (typically greater than 95% across the visible range), thermally conductive, and may be formed of a material able to withstand temperatures of up to 105° C. and fluxes of up to 1 W/cm² without any significant degradation of reflective properties across visible wavelengths or mechanical and structural integrity. If uncoated, housing 10 must have sufficient thickness to maintain bulk reflectivity, and may have any machined, printed, or molded surface finish that maintains a high reflectivity. Housing 10 may be coated with a white reflective paint or other coating such as Star-Brite White EF (available from SPRAYLAT Sign Coatings) or a barium sulfate based white paint, thermal sprays that include ceramic(s), polymer sprays that include Teflon PTFE, or specularly reflective coatings such as Aluminum or Silver.

Housing 10 may be formed of a plastic or polymer. For example, housing 10 may be formed of, or coated with, polycarbonate or polytetrafluoroethylene. Housing 10 may also be formed of metal, such as aluminum, tin, zinc, magnesium, or an alloy including at least one of the foregoing. Housing 12 can also be formed of other materials such as Makrolon® by Bayer, Lexan® by GE, OP.DI.MA. by Gigahertz-Optik, polyethylene terephthalate (PET), micro cell polyethylene terephthalate (MCPET), GORE® Diffuse Reflector Product, Idemitsu URC2501, and Delrin® and Teflon by Dupont, for example. Other suitable materials for housing 10 will become readily apparent to those skilled in the art, given the benefit of this disclosure.

Housing 10 may be formed by machining, stamping, extrusion, molding, 3D printing, or casting, for example. Other suitable ways of forming housing 10 will become readily apparent to those skilled in the art, given the benefit of this disclosure.

As illustrated in FIGS. 4 and 5, shelf 42 is sized with a depth D such that an inner edge 54 of shelf 42 is positioned inwardly of an outer edge 56 of cavity 46. By having shelf 42 and cavity 46 overlap one another in this manner, blue light will not leak past color converting material 48 without being absorbed. This helps eliminate an unwanted shift of the front-of-screen color point and possible non-uniformity of the LCD screen.

Additionally, by positioning shelf 42 such that that a portion of each of first walls 30 and second walls 32 extends upwardly beyond shelf 42 to second end 40, housing 10 redirects light that may escape from edges of chamber 44 back into glass chamber 44. This redirection of light serves to eliminate an unwanted shift of the front-of-screen color point and possible non-uniformity of the LCD screen.

In certain embodiments, housing 10 may include one or more fasteners to secure color converting assembly 18 to housing 10. For example, as seen in FIGS. 7-8, each of a pair of fasteners 58 is positioned at the top, or second, end 40 of opposed walls of housing 10. As illustrated here, fasteners 58 are positioned on second opposed walls 32. It is to be appreciated that fasteners 58 could also be positioned at second end 40 of first opposed walls 30. In the illustrated embodiment, each fastener 58 is a conventional snap-fit fastener including an upwardly extending resilient tab 60 and a finger 62 extending outwardly from tab 60. Fastener 58 is sized such that finger 62 extends over the top of color converting assembly 18, as seen in FIG. 8. As seen in FIG. 8, finger 62 has a depth R, which is sized such that finger 62 does not overlap with cavity 46 and does not interfere with light passing outwardly from color converting material 48. In certain embodiments, the upper surface of finger 62 may be tapered to facilitate placing color converting assembly 18 on shelf 42. As color converting assembly 18 is pressed downwardly, it will smoothly pass over the tapered upper surface of finger 62, helping guide color converting assembly 18 into the proper position on shelf 42.

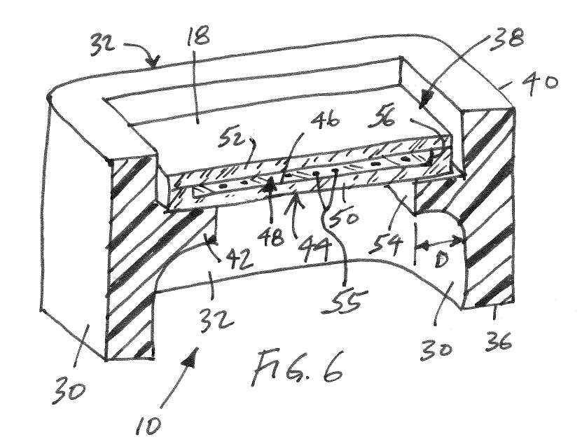

In certain embodiments, as illustrated in FIGS. 9-10, housing 10 includes a first pair of opposed interior walls 64 extending downwardly in and inwardly from shelf 42 between first opposed walls 30, and a second pair of opposed interior walls 66 extending downwardly in and inwardly from shelf 42 between first opposed walls 32. Interior walls 64 and 66 define a third opening 68 at first end 36 of housing 10, which is positioned directly above LED 14 when housing 10 is mounted to PCB 16.

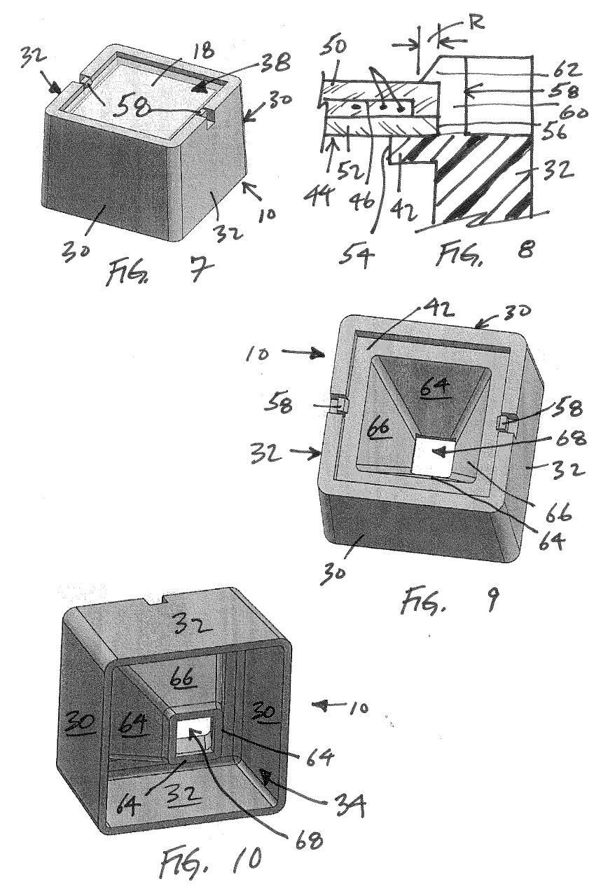

In certain embodiments, housing 10 is secured to PCB 16 with glue, epoxy, or any of various other adhesives. In other embodiments, housing 10 may be secured to PCB 16 with a fastener. As seen in FIG. 11, housing 10 may include a conventional snap-fit fastener 70 including a pair of downwardly extending resilient tabs 72 and fingers 74 extending outwardly from tabs 72. Tabs 72 are received in an aperture 76 formed in PCB 16, with fingers 74 engaging the bottom surface of PCB 16 so as to retain housing 10 on PCB 16. As seen here, fastener 70 is formed on the first end 36 of a first wall 30. It is to be appreciated that fastener 70 may be formed on a second wall 32, and that more than one fastener 70 can be included on housing 10. Using a fastener to secure housing 10 to PCB 16 allows housing 10 to be quickly and accurately positioned on PCB 16 at a desired location directly above LED 14, decreasing manufacturing time, while increasing accuracy and, therefore, performance of backlight 12.

In other embodiments, one or more fasteners may be formed on PCB 16 in order to retain housing 10. For example, as seen in FIG. 12, PCB 16 may include a conventional snap-fit fastener 78 including a pair of upwardly extending resilient tabs 80 and fingers 82 extending outwardly from tabs 80. Tabs 80 are received in an aperture 84 formed in a flange 86 extending outwardly from the first end of a first wall 30. Fingers 82 engage the top surface of flange 86 so as to retain housing 10 on PCB 16. As seen here, flange 86 is formed on the first end 36 of a first wall 30. It is to be appreciated that flange 86 may be formed on a second wall 32, and that more than one fastener 78 can be used to secure each housing 10 to PCB 16.

In other embodiments, as seen in FIG. 13, a fastener for use with housing 10 includes a tab 88 extending downwardly from a bottom surface of a first wall 30. Tab 88 is received in an aperture 90 formed in PCB 16. An adhesive may then be used to secure tab 88 within aperture 90. Suitable adhesives for securing tab 88 within aperture 90 will become readily apparent to those skilled in the art, given the benefit of this disclosure. As seen here, tab 88 is formed on the first end 36 of a first wall 30. It is to be appreciated that tab 88 may be formed on a second wall 32, and that more than one tab 88 can be used to secure each housing 10 to PCB 16.

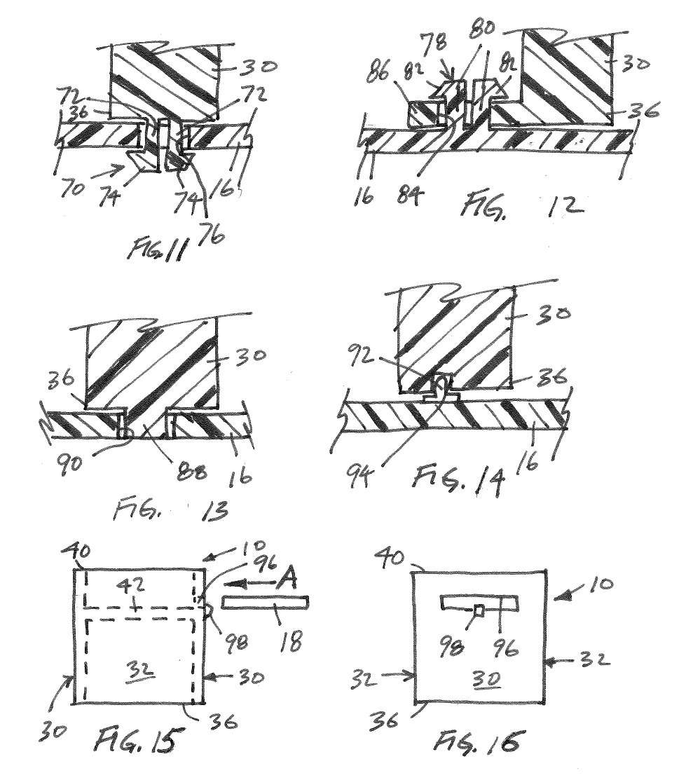

In further embodiments, as seen in FIG. 14, a fastener for use with housing 10 includes a tab 92 extending upwardly from PCB 16. Tab 92 is received in an aperture 94 formed in a bottom of first wall 30. An adhesive may then be used to secure tab 92 within aperture 94. Suitable adhesives for securing tab 92 within aperture 94 will become readily apparent to those skilled in the art, given the benefit of this disclosure. As illustrated here, tab 92 is a separate element secured to a top surface of PCB 16 with an adhesive, for example. It is to be appreciated that in certain embodiments tab 92 could be formed as an integral part of PCB 16, and need not be a separate element that is secured to PCB 16.

It is to be appreciated that there are numerous types of fasteners, and locations for the fasteners, that can be used to accurately place and secured housing 10 on PCB 16. Other suitable fasteners, and locations, will become readily apparent to those skilled in the art, given the benefit of this disclosure.

In certain embodiments, as illustrated in FIGS. 15-16, color converting assembly 18 can be inserted into housing 10 in a direction A through a slot 96 formed in one of the walls of housing 10 just above shelf 42. As illustrated here, slot 96 is formed in a first wall 30, although it is to be appreciated that slot 96 can also be formed in a second wall 32. Color converting assembly 18 can be retained or secured within housing 10 by a fastener 98 on housing 10. In the illustrated embodiment, fastener 98 is a resilient arm or clip that engages a side of color converting assembly 18 once it is fully inserted into slot 96 past fastener 98.

Thus, while there have been shown, described, and pointed out fundamental novel features of various embodiments, it will be understood that various omissions, substitutions, and changes in the form and details of the housing and color converting assembly illustrated, and in their operation, may be made by those skilled in the art without departing from the spirit and scope of the invention. For example, it is expressly intended that all combinations of those elements and/or steps which perform substantially the same function, in substantially the same way, to achieve the same results are within the scope of the invention. Substitutions of elements from one described embodiment to another are also fully intended and contemplated.

Applicant specifically incorporates the entire contents of all cited references (e.g., papers, patent documents, patent publications, etc.) in this disclosure. Further, when an amount, concentration, or other value or parameter is given as either a range, preferred range, or a list of upper preferable values and lower preferable values, this is to be understood as specifically disclosing all ranges formed from any pair of any upper range limit or preferred value and any lower range limit or preferred value, regardless of whether ranges are separately disclosed. Where a range of numerical values is recited herein, unless otherwise stated, the range is intended to include the endpoints thereof, and all integers and fractions within the range. It is not intended that the scope of the invention be limited to the specific values recited when defining a range.

Other embodiments of the present invention will be apparent to those skilled in the art from consideration of the present specification and practice of the present invention disclosed herein. It is intended that the present specification and examples be considered as exemplary only with a true scope and spirit of the invention being indicated by the following claims and equivalents thereof.

What is claimed is:

1. An assembly comprising:
a housing comprising:
a first pair of opposed walls and a second pair of opposed walls, the housing having a first opening at a first end thereof and a second opening at a second end thereof; and
a shelf extending inwardly from each of the walls at a point below the second end of the housing such that each wall extends upwardly beyond the shelf to the second end of the housing;
wherein the walls and shelf are formed of a reflective material.

2. The assembly of claim 1, wherein the walls and shelf are formed of polycarbonate.

3. The assembly of claim 1, wherein the walls and shelf are formed of polytetrafluoroethylene.

4. The assembly of claim 1 further comprising a pair of fasteners, each fastener having a portion extending inwardly from one of the walls at a position above the shelf.

5. The assembly of claim 4, wherein the fasteners are resilient tabs biased inwardly from the corresponding wall.

6. The assembly of claim 1, further comprising a fastener on one of the walls.

7. The assembly of claim 6, wherein the fastener is a snap-fit member including a pair of downwardly extending tabs, each tab including an outwardly extending finger.

8. The assembly of claim 6, wherein the fastener is a tab at the first end of the housing and extending downwardly from the one of the walls.

9. The assembly of claim 1, further comprising a slot formed in and extending through one of the walls at a point above the shelf.

10. The assembly of claim 9, further comprising a fastener on an exterior of the wall at a bottom of the slot.

11. The assembly of claim 1, further comprising a first pair of opposed interior walls extending downwardly and inwardly from the shelf and a second pair of opposed interior walls extending downwardly and inwardly from the shelf, the first and second pairs of interior walls defining a third opening.

12. The assembly of claim 11, wherein a bottom of each of the first and second pairs of interior walls is flush with a bottom of the first and second pairs of opposed walls.

13. An assembly including:
a housing comprising:
a first pair of opposed walls and a second pair of opposed walls, the housing having a first opening at a first end thereof and a second opening at a second end thereof; and
a shelf extending inwardly from each of the walls at a point below the second end of the housing such that each wall extends upwardly beyond the shelf to the second end of the housing; and
a color converting assembly seated on the shelf and comprising:
a chamber having a cavity formed therein; and
a color converting material is received in the chamber.

14. The assembly of claim 13, wherein the walls and shelf are formed of polycarbonate.

15. The assembly of claim 13, wherein the walls and shelf are formed of polytetrafluoroethylene.

16. The assembly of claim 13, further comprising a pair of fasteners, each fastener having a portion extending inwardly from one of the walls at a position above the shelf.

17. The assembly of claim 16, wherein the fasteners are resilient tabs biased inwardly from the corresponding wall.

18. The assembly of claim 13, further comprising a fastener on one of the walls.

19. The assembly of claim 18, wherein the fastener is a snap-fit member including a pair of downwardly extending tabs, each tab including an outwardly extending finger.

20. The assembly of claim 18, wherein the fastener is a tab at the first end of the housing and extending downwardly from the one of the walls.

21. The assembly of claim 13, further comprising a slot formed in and extending through one of the walls at a point above the shelf.

22. The assembly of claim 21, further comprising a fastener on an exterior of the wall at a bottom of the slot.

23. The assembly of claim 13, further comprising a first pair of opposed interior walls extending downwardly and inwardly from the shelf and a second pair of opposed interior walls extending downwardly and inwardly from the shelf, the first and second pairs of interior walls defining a third opening.

24. The assembly of claim 23, wherein a bottom of each of the first and second pairs of interior walls is flush with a bottom of the first and second pairs of opposed walls.

25. The assembly of claim 13, wherein the chamber is formed of a first portion defining the cavity and a second portion secured to the first portion and covering the cavity.

26. The assembly of claim 13, wherein the color converting material includes scattering elements.

27. The assembly of claim 13, wherein the color converting material comprises quantum dots.

28. The assembly of claim 13, wherein the color converting material comprises phosphors.

29. The assembly of claim 13, wherein the color converting material comprises a fluorescent material.

30. The assembly of claim 13, wherein the chamber is formed of glass.

31. An assembly including:
a PCB;
an LED secured to the PCB;
a housing having a first end secured to the PCB and comprising:
a first pair of opposed walls and a second pair of opposed walls, the housing having a first opening at the first end and a second opening at a second end thereof, the LED extending upwardly into the first opening; and
a shelf extending inwardly from each of the walls at a point below the second end of the housing such that each wall extends upwardly beyond the shelf to the second end of the housing;
a color converting assembly seated on the shelf and comprising:
a chamber having a cavity formed therein; and
a color converting material received in the chamber.

32. The assembly of claim 31, wherein the walls and shelf are formed of polycarbonate.

33. The assembly of claim 31, wherein the walls and shelf are formed of polytetrafluoroethylene.

34. The assembly of claim 31, further comprising a pair of fasteners, each fastener having a portion extending inwardly from one of the walls at a position above the shelf.

35. The assembly of claim 34, wherein the fasteners are resilient tabs biased inwardly from the corresponding wall.

36. The assembly of claim 31, further comprising a fastener on one of the walls.

37. The assembly of claim 36, further comprising an aperture in the PCB,
wherein the fastener is a snap-fit member including a pair of downwardly extending tabs, each tab including an outwardly extending finger, the aperture releasably receiving the fastener.

38. The assembly of claim 36, further comprising:
an aperture in the PCB, the aperture receiving the fastener; and
adhesive securing the fastener within the aperture.

39. The assembly of claim 31, further comprising:
at least one flange extending outwardly from the first end of one of the walls, the at least one flange including an aperture; and
a fastener extending upwardly from the PCB, the fastener being received in the aperture.

40. The assembly of claim 39, wherein the fastener is a snap-fit member including a pair of upwardly extending tabs, each tab including an outwardly extending finger, the aperture releasably receiving the fastener.

41. The assembly of claim 31, further comprising a slot formed in and extending through one of the walls at a point above the shelf.

42. The assembly of claim 41, further comprising a fastener on an exterior of the wall at a bottom of the slot.

43. The assembly of claim 31, further comprising a first pair of opposed interior walls extending downwardly and inwardly from the shelf and a second pair of opposed interior walls extending downwardly and inwardly from the shelf, the first and second pairs of interior walls defining a third opening.

44. The assembly of claim 43, wherein a bottom of each of the first and second pairs of interior walls is flush with a bottom of the first and second pairs of opposed walls.

45. The assembly of claim 31, wherein the chamber is formed of a first portion defining the cavity and a second portion secured to the first portion and covering the cavity.

46. The assembly of claim 31, wherein the matrix of color converting material includes scattering elements.

47. The assembly of claim 31, wherein the color converting material comprises quantum dots.

48. The assembly of claim 31, wherein the color converting material comprises phosphors.

49. The assembly of claim 31, wherein the color converting material comprises a fluorescent material.

50. The assembly of claim 31 further including:
a lens positioned above the housing;
a first diffuser positioned above the lens; and
an LCD positioned above the first diffuser.

51. The assembly of claim 31 further including:
a lens positioned above the housing.

52. The assembly of claim 31 further including:
a first diffuser positioned above the housing; and
an LCD positioned above the first diffuser.

53. The assembly of claim 50, further comprising a second diffuser positioned between the first diffuser and the LCD.

54. The assembly of claim 52, further comprising a second diffuser positioned between the first diffuser and the LCD.

55. The assembly of claim 53, wherein the second diffuser has a thickness less than a thickness of the first diffuser.

56. The assembly of claim 54, wherein the second diffuser has a thickness less than a thickness of the first diffuser.

57. The assembly of claim 50, further comprising a first brightness enhancing film positioned between the first diffuser and the LCD.

58. The assembly of claim 52, further comprising a first brightness enhancing film positioned between the first diffuser and the LCD.

59. The assembly of claim 57, further comprising a second brightness enhancing film positioned between the first brightness enhancing film and the LCD.

60. The assembly of claim 58, further comprising a second brightness enhancing film positioned between the first brightness enhancing film and the LCD.

61. The assembly of claim 31, further comprising layer of reflective material positioned on a surface of the PCB.

62. The assembly of claim 31, wherein the chamber is formed of glass.

63. An assembly including:
a PCB;
an LED secured to the PCB; and
a housing having a first end secured to the PCB and comprising:
a first pair of opposed walls and a second pair of opposed walls, the housing having a first opening at the first end and a second opening at a second end thereof, the LED extending upwardly into the first opening; and
a shelf extending inwardly from each of the walls at a point below the second end of the housing such that each wall extends upwardly beyond the shelf to the second end of the housing.
